(19) United States
(12) Patent Application Publication
(10) Pub. No.: US 2026/0138907 A1
(43) Pub. Date: May 21, 2026

(54) METHOD FOR MANUFACTURING MEMBER, APPARATUS FOR MANUFACTURING MEMBER, AND DIE

(71) Applicant: CANON KABUSHIKI KAISHA, Tokyo (JP)

(72) Inventors: NORIHIRO FURUKAWA, Tochigi (JP); SHIGEO URAI, Saitama (JP)

(21) Appl. No.: 19/387,879

(22) Filed: Nov. 13, 2025

(30) Foreign Application Priority Data
Nov. 20, 2024 (JP) 2024-202515

(51) Int. Cl. C03B 11/08; C03B 11/12

(52) U.S. Cl. CPC C03B 11/084; C03B 11/125; C03B 2215/06

(57) ABSTRACT

A method for manufacturing a member includes: a molding step of molding, by using a die having a first die member with a first molding surface and a second die member with a second molding surface and causing the first and second molding surfaces to approach each other, a material to be molded into a member by heating and pressing the material to be molded between the first molding surface and the second molding surface; a cooling step of cooling the die after the molding step; and a demolding step of demolding the member from the die after the molding step, wherein at least one of the first and second die members has a material part or a space part that changes a curvature of the first molding surface or the second molding surface, due to a change in heat or load in the cooling step or the demolding step.

### BACKGROUND

### Field of the Technology

The present disclosure relates to a method for manufacturing member, an apparatus for manufacturing member, and a die.

### Description of the Related Art

In recent years, due to the increase in magnification and the miniaturization of optical instruments or devices, there has been a demand for highly precise and compact optical systems. Optical elements made of resin or glass are used in these optical systems, and the need to mold optical elements with small outer diameters has increased with the miniaturization of products. In the molding of a small-diameter optical element, since the diameter of the die and the optical element are small, the amount of thermal shrinkage becomes small, and the die and the optical element may not be released. Therefore, a method for releasing a die and an optical element has been proposed.

Japanese Patent Laid-Open No. 2007-191359 discloses a method for releasing a die by projecting a release member from the molding surface of the die and bringing the release member into contact with an optical element and applying an external force when releasing the die and the optical element.

In addition, there is a method disclosed in Japanese Patent Laid-Open No. H05-147955 as a method that is different from a method for releasing a die by bringing a release member into contact with an optical element. Japanese Patent Laid-Open No. H05-147955 discloses a method for releasing an optical element from a die by forming a thin elastic portion on the outer peripheral portion of the die and applying an external force to the elastic portion to change the curvature of the outer peripheral portion.

However, in the method for releasing the molding die by applying an external force as described in Japanese Patent Laid-Open No. 2007-191359, the optical element may be damaged or cracked before being released from the molding die. In addition, in the method for deforming the thin elastic portion of the outer peripheral portion of the die as described in Japanese Patent Laid-Open No. H05-147955, there is a possibility that the molding apparatus becomes complicated and the cost of the optical element increases.

### SUMMARY

The present disclosure is directed to a method for manufacturing a member, an apparatus for manufacturing a member, and a die capable of easily releasing the die from the member without causing scratches or cracks.

According to an aspect of the present disclosure, there is provided a method for manufacturing a member, the method including: a molding step of molding, by using a die having a first die member with a first molding surface and a second die member with a second molding surface and causing the first molding surface and the second molding surface to approach each other, a material to be molded into a member by heating and pressing the material to be molded between the first molding surface and the second molding surface; a cooling step of cooling the die after the molding step; and a demolding step of demolding the member from the die after the molding step, wherein at least one die member of the first die member and the second die member has a material part or a space part that changes a curvature of the first molding surface or the second molding surface, which is a molding surface, due to a change in heat or load in the cooling step or the demolding step.

According to another aspect of the present disclosure, there is provided an apparatus for manufacturing a member, the apparatus including: a die having a first die member with a first molding surface and a second die member with a second molding surface; a drive system that causes the first molding surface and the second molding surface to approach each other or to separate from each other; and a temperature control unit that controls a temperature of the die, wherein at least one die member of the first die member and the second die member has a material part or a space part that changes a curvature of the first molding surface or the second molding surface, which is a molding surface, due to a change in heat or load.

According to another aspect of the present disclosure, there is provided a die including: a first die member having a first molding surface; and a second die member having a second molding surface, wherein at least one die member of the first die member and the second die member has a material part or a space part that changes a curvature of the first molding surface or the second molding surface, which is a molding surface, due to a change in heat or load.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic diagram illustrating an optical element molding apparatus according to a first embodiment of the present disclosure.

FIG. 1B is a cross-sectional view illustrating a state in which a molding die is opened before a pressing operation in the optical element molding apparatus according to the first embodiment of the present disclosure.

FIG. 1C is a cross-sectional view illustrating a state in which the molding die is closed and a material to be molded is pressed in the optical element molding apparatus according to the first embodiment of the present disclosure.

FIG. 1D is a cross-sectional view illustrating a state in which the molding die is opened after demolding in the optical element molding apparatus according to the first embodiment of the present disclosure.

FIG. 2 is an enlarged cross-sectional view illustrating a change in a molding surface during a molding step in the optical element molding apparatus according to the first embodiment of the present disclosure.

FIG. 3 is an enlarged cross-sectional view illustrating a change in the molding surface during a demolding step in the optical element molding apparatus according to the first embodiment of the present disclosure.

FIG. 4 is a schematic view illustrating an optical element molding apparatus according to a second embodiment of the present disclosure.

FIG. 5 is a schematic diagram illustrating an optical element molding apparatus according to a third embodiment of the present disclosure.

FIG. 6 is an enlarged cross-sectional view illustrating a change in a molding surface during a molding step in the optical element molding apparatus according to a third embodiment of the present disclosure.

FIG. 7 is an enlarged cross-sectional view illustrating a change in the molding surface during a demolding step in the optical element molding apparatus according to the third embodiment of the present disclosure.

FIG. 8 is a schematic diagram illustrating an optical element molding apparatus according to a fourth embodiment of the present disclosure.

FIG. 9 is a schematic diagram illustrating an optical element molding apparatus according to a fifth embodiment of the present disclosure.

### DESCRIPTION OF THE EMBODIMENTS

### First Embodiment

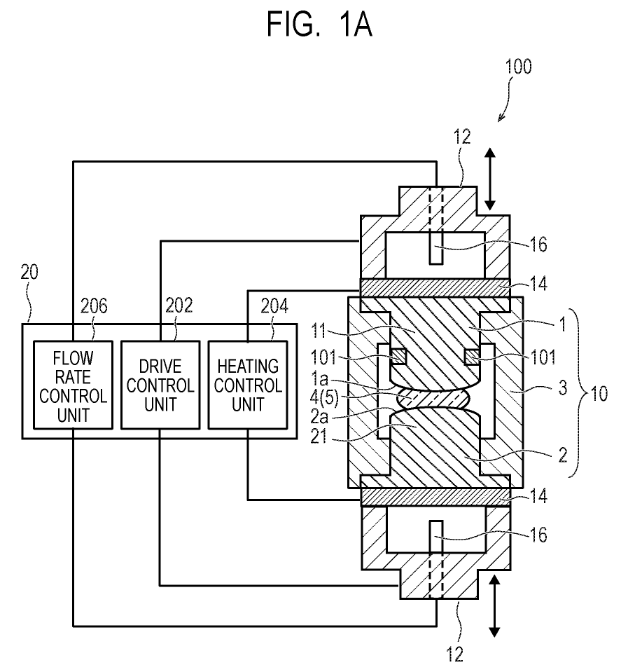

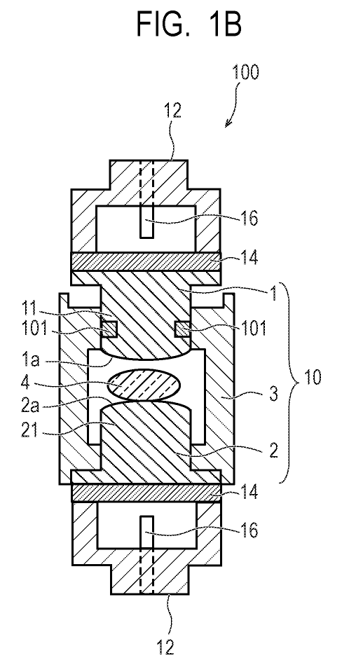

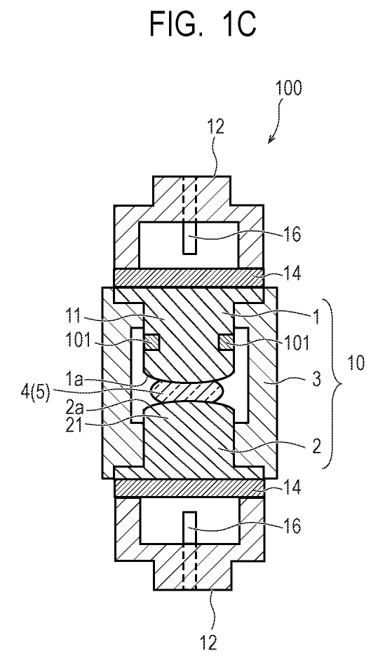

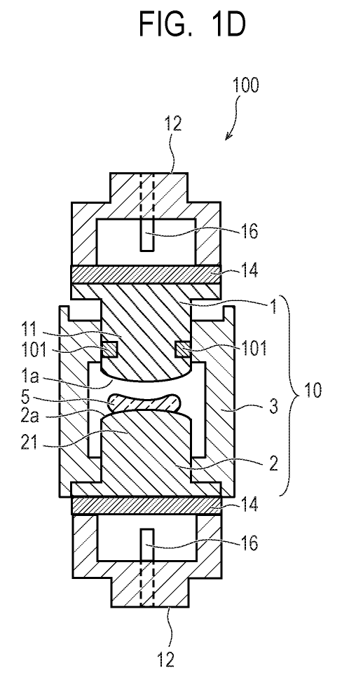

A method for manufacturing an optical element, an apparatus for manufacturing an optical element, and a die according to a first embodiment of the present disclosure will be described with reference to FIG. 1A to FIG. 3. In the present embodiment, a case of manufacturing an optical element as an example of a member will be described. Note that the embodiments presented below are examples, and for example, the configurations of the details can be appropriately modified and implemented without departing from the scope and spirit of the present disclosure. In addition, in the drawings referred to in the description of the following embodiments, elements denoted by the same reference numbers have the same function unless otherwise specified. In addition, when a plurality of the same elements are arranged in the drawings, reference numerals and explanations thereof may be omitted. In addition, for convenience of illustration and explanation, the shape, size, arrangement, and the like of the elements described in the drawings may be schematically indicated.

First, the configuration of an apparatus for manufacturing an optical element according to the present embodiment will be described with reference to FIG. 1A. FIG. 1A is a schematic diagram illustrating an optical element molding apparatus 100 according to the present embodiment. Note that FIG. 1A illustrates a state of a molding die 10 during a pressing operation described later.

The molding apparatus 100 according to the present embodiment is an apparatus for manufacturing an optical element, which manufactures an optical element by press molding. As illustrated in FIG. 1A, the molding apparatus 100 according to the present embodiment includes a molding die 10, a drive system 12, a heater 14, a gas inlet pipe 16, and a controller 20.

The molding die 10 includes a cylindrical upper die member 1 for example, a cylindrical lower die member 2 for example, and a body die 3. The upper die member 1 is a die member as a first die for press-molding an optical element. The lower die member 2 is a die member as a second die for press-molding the optical element. The body die 3 is a holding part for holding the upper die member 1 and the lower die member 2. The molding die 10 is a mold in which the upper die member 1, the lower die member 2, and the body die 3 are made of metal, for example, but the body die 3 may be a mold in which all or part of the upper die member 1, the lower die member 2, and the body die 3 are made of materials other than metal.

The upper die member 1 has a main body part 11 having a molding surface 1a for molding the optical functional surface of the optical element on the bottom surface of the cylindrical shape as a base material of the die. The lower die member 2 has a main body part 21 having a molding surface 2a for molding the optical functional surface of the optical element on the bottom surface of a cylindrical shape as a base material of the die. The molding surfaces 1a and 2a have shapes corresponding to the optical functional surfaces of the optical element to be formed, and have shapes corresponding to one surface and the other surface of the optical element that are opposite to each other. For example, each of the molding surfaces 1a and 2a of the upper die member 1 and the lower die member 2 may have a convex shape so that the optical element has a shape of a biconcave lens.

One or both of the upper die member 1 and the lower die member 2 have dissimilar material parts 101 provided on the main body parts 11 and 21. The dissimilar material part 101 is a material part composed of a material having physical properties different from those of the main body part 11 of the upper die member 1 or the main body part 21 of the lower die member 2, which is the base material of the die in which the dissimilar material part 101 is provided. Note that, in the following description, a case where the dissimilar material part 101 is provided in the main body part 11 of the upper die member 1 among the upper die member 1 and the lower die member 2 is explained as an example, but the dissimilar material part 101 may also be provided in the main body part 21 of the lower die member 2 as in the case of the upper die member 1.

The dissimilar material part 101 is provided in the outer peripheral portion of the main body part 11 along the circumferential direction of the side face of the main body part 11 so as to be positioned outside the cylindrical main body part 11. The dissimilar material part 101 may be continuously or intermittently annularly provided in the outer peripheral portion of the main body part 11 or may be partially provided.

Specifically, the dissimilar material part 101 is composed of a material having an elastic modulus smaller than that of the main body part 11 which is a base material of the die. The material of the main body part 11, the material of the main body part 21 and the material of the dissimilar material part 101 are all, for example, cemented carbide. The elastic modulus of the main body part 11 is, for example, 600 GPa, and the elastic modulus of the dissimilar material part 101 is, for example, 400 GPa. Note that it is preferable that the dissimilar material part 101 is provided at a position sufficiently distant from the molding surface 1a.

The main body part 11 and the main body part 21, which are the base materials of the die, and the dissimilar material part 101 are preferably highly strong and highly heat-resistant from the viewpoint of durability. From this viewpoint, materials such as tungsten carbide (WC) based cemented carbide, silicon carbide, silicon nitride, stainless steel or the like may be used as the materials constituting the main body part 11, the main body part 21 and the dissimilar material part 101, for example.

The body die 3 is provided with a through hole penetrating in the vertical direction. The upper die member 1 and the lower die member 2 are slidably inserted in the through hole of the body die 3. The upper die member 1 is positioned above the lower die member 2. The upper die member 1 and the lower die member 2 are arranged so that their respective molding surfaces 1a and 2a face each other. A material to be molded 4, which will be molded into an optical element is arranged between the molding surface 1a and the molding surface 2a.

The drive system 12 slides one or both of the upper die member 1 and the lower die member 2 in the vertical direction during the molding of the optical element. Thus, the drive system 12 makes the upper die member 1 and the lower die member 2 close to each other in the vertical direction to make the molding surface 1a and the molding surface 2a close to each other, and presses the material to be molded 4 between the molding surface 1a and the molding surface 2a. Furthermore, the drive system 12 slides one or both of the upper die member 1 and the lower die member 2 in the vertical direction during releasing the molded optical element from the die. Thus, the drive system 12 opens the die by separating the upper die member 1 and the lower die member 2 from each other and thus separating the molding surface 1a and the molding surface 2a from each other in the vertical direction. The operation of the drive system 12 is controlled by the controller 20.

The heater 14 is a heating unit that heats the molding die 10 including the upper die member 1, the lower die member 2 and the body die 3 and the material to be molded 4 to a temperature suitable for press molding. The heater 14 is one of temperature control units that control the temperature of the molding die 10. The heater 14 is provided so as to contact, for example, the bottom surface of the upper die member 1 opposite to the molding surface 1a and the bottom surface of the lower die member 2 opposite to the molding surface 2a. The output of the heater 14 is controlled by the controller 20 so that the temperature of the molding die 10 becomes a desired temperature based on the detection result of a temperature sensor (not illustrated).

The gas inlet pipe 16 is a cooling unit that cools the molding die 10 to a temperature at which the optical element, which is a molded product, can be taken out after press molding. The gas inlet pipe 16 is one of the temperature control units that control the temperature of the molding die 10. The gas inlet pipe 16 is configured to blow cooling gas such as N₂ gas to the upper die member 1, the lower die member 2, the body die 3 and the heater 14, which are the targets to be cooled. The cooling gas flow rate in the gas inlet pipe 16 is controlled by a controller 20. Note that the cooling unit that cools the molding die 10 is not limited to the gas inlet pipe 16, but may be one that cools the molding die 10 with another cooling mechanism.

The controller 20 is an information processing apparatus functioning as a control unit that manages and controls each part of the molding apparatus 100. The controller 20 includes a processor (not illustrated) that executes various processes such as calculation, control, determination, and the like. Furthermore, the controller 20 also includes a storage (not illustrated) that stores various control programs executed by the processor, database referenced by the processor, and the like. Furthermore, the controller 20 also includes a memory (not illustrated) that temporarily stores data being processed by the processor, input data, and the like. Note that the controller 20 is not particularly limited, but may be configured by a general-purpose computer device such as a personal computer, or may be configured by a computer device dedicated to the molding apparatus 100. Note also that each function of the controller 20 may be realized by a single computer device or by a plurality of computer devices.

The controller 20 includes, as functional units, a drive control unit 202 that controls the operation of the drive system 12, a heating control unit 204 that controls the output of the heater 14, and a flow rate control unit 206 that controls the flow rate of the cooling gas in the gas inlet pipe 16. The drive control unit 202 controls the sliding of one or both of the upper die member 1 and the lower die member 2 in the vertical direction by controlling the operation of the drive system 12. The heating control unit 204 controls the temperature of the molding die 10 by controlling the output of the heater 14 based on the detection result of a temperature sensor (not illustrated). The flow rate control unit 206 controls the temperature of the molding die 10 by controlling the flow rate of the cooling gas in the gas inlet pipe 16. At the time of cooling, the controller 20 controls the output of the heater 14 and the flow rate of the cooling gas in the gas inlet pipe 16, so that the upper die member 1, the lower die member 2 and the body die 3 can be cooled at a desired cooling rate.

The material to be molded 4 is a material which can be molded into an optical element such as a glass material, a thermoplastic resin, or the like. The glass material is an optical glass such as an optical glass for glass mold, or the like, and is such as borosilicate based glass, lanthanum based glass, fluorophosphate based glass, or the like, for example. The thermoplastic resin is, for example, a cycloolefin resin or the like. Furthermore, when the optical element to be molded is a composite lens composed of glass and resin, a composite material of corresponding glass and resin can be used as the material to be molded 4.

Note that the shape of the optical element to be molded in the molding apparatus 100 is not particularly limited, but is different for each optical system to be designed, such as a concave lens, a convex lens, or the like, for example.

Next, a method for manufacturing an optical element using the molding apparatus 100 according to the present embodiment will be described with reference to FIG. 1B to FIG. 1C. FIG. 1B is a cross-sectional view illustrating a state in which the molding die 10 is opened before the pressing operation in the molding apparatus 100. FIG. 1C is a cross-sectional view illustrating a state in which the molding die 10 is closed and the material to be molded 4 is pressed during the pressing operation in the molding apparatus 100.

The method for manufacturing an optical element using the molding apparatus 100 according to the present embodiment includes a heating step, a molding step, a cooling step and a demolding step, which are sequentially performed. Note that the molding process including these steps is preferably performed under an atmosphere of an inert gas such as N₂ gas in order to prevent oxidation of the molding die 10 and the apparatus. In addition, the temperature and the press load selected in the successive molding process can be appropriately set in terms of the type of the material to be molded 4 to be used and the shape of the optical element as a molded product.

Before starting the heating step, the molding die 10 is in an open state, and a predetermined space is provided between the upper die member 1 and the lower die member 2. First, in the heating step, the controller 20 controls the output of the heater 14 to heat the entire molding die 10 by the heater 14, and heat the molding die 10 to a predetermined temperature. When the molding die 10 is heated to the predetermined temperature, as illustrated in FIG. 1B, the material to be molded 4 is placed on the center of the molding surface 2a of the lower die member 2, and the material to be molded 4 is arranged between the molding surface 1a of the upper die member 1 and the molding surface 2a of the lower die member 2. Thus, the material to be molded 4 is arranged in the molding die 10. As the material to be molded 4, for example, an optical glass for glass mold having a glass transition point of 510°C may be used.

Furthermore, in the heating step, the controller 20 controls the output of the heater 14 to heat the entire molding die 10 by the heater 14 and heat the material to be molded 4 arranged in the molding die 10 to make the material to be molded 4 softened.

Specifically, in the heating step, the upper die member 1, the lower die member 2, and the body die 3 are heated to a first temperature (for example, 460°C), and then the material to be molded 4 is arranged at the center of the molding surface 2a of the lower die member 2. Thereafter, the controller 20 heats the molding die 10 to a second temperature (for example, 570°C), which is higher than the first temperature, and softens the material to be molded 4 until the viscosity of the material to be molded 4 is lowered to a state suitable for molding.

Next, the controller 20 moves to the molding step, which performs a press operation in the molding apparatus 100. In the molding step, as illustrated in FIG. 1C, the controller 20 controls the operation of the drive system 12 to slide the upper die member 1 downward toward the lower die member 2 whose position is fixed, and presses the heated and softened material to be molded 4 with a press load. The press load may be set to, for example, 4000 N. Thus, the controller 20 transfers the shapes of the molding surfaces 1a and 2a of the upper die member 1 and the lower die member 2 to the material to be molded 4 to mold the material to be molded 4 to a desired center thickness. Note that, from the viewpoint of softening the material to be molded 4 to a state suitable for molding, it is preferable that the controller 20 performs the molding step in a state in which the material to be molded 4 is heated to a temperature higher than the glass transition point of the material to be molded 4 by the heater 14. Thus, the controller 20 molds the material to be molded 4 into an optical element 5 by pressing the material to be molded 4 between the molding surface 1a and the molding surface 2a while heating the material to be molded 4 by bringing the upper die member 1 and the lower die member 2 close to each other in the vertical direction.

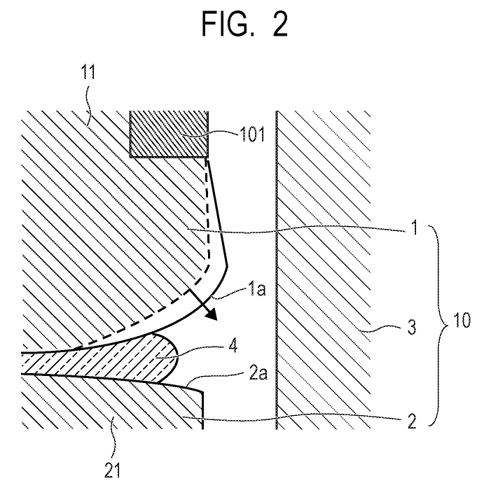

Here, the elastic modulus of the dissimilar material part 101 is smaller than that of the main body part 11 of the upper die member 1. Thus, the outer peripheral portion of the upper die member 1 provided with the dissimilar material part 101 is more deformed by the load than the central portion of the upper die member 1 formed only by the main body part 11. Therefore, the upper die member 1 deforms more largely in its outer peripheral portion than in its central portion by the press load in the molding step. As a result, as illustrated in FIG. 2, the molding surface 1a of the upper die member 1 when the press load is applied has a radius of curvature larger than the radius of curvature when the press load is not applied. Thus, the dissimilar material part 101 changes the curvature of the molding surface 1a in response to the change of the load. The shape of the molding surface 1a having a larger radius of curvature is transferred to the material to be molded 4. Accordingly, the material to be molded 4 is molded, and an optical element 5 formed of the molded material to be molded 4 is obtained.

After the molding of the material to be molded 4 is completed, the controller 20 controls the operation of the drive system 12 to hold the press load for pressing the material to be molded 4 to a certain extent and moves to the next cooling step. Here, the reason for holding the press load to a certain extent is to prevent the material to be molded 4 from separating from the molding die 10 due to the difference in thermal shrinkage between the molding die 10 and the material to be molded 4.

In the cooling step, the controller 20 controls the flow rate of the cooling gas in the gas inlet pipe 16 to control the cooling gas blown out from the gas inlet pipe 16, thereby cooling the molding die 10 and the optical element 5 until the molding die 10 and the optical element 5 serving as a molded product become a desired temperature. Specifically, the controller 20 cools the molding die 10 until the molding die 10 reaches a third temperature (for example, 460°C) lower than the second temperature.

When the molding die 10 is cooled to a desired temperature, the controller 20 moves to the demolding step. Note that the controller 20 may start the demolding step after starting the cooling step, and may continue the cooling step even after starting the demolding step.

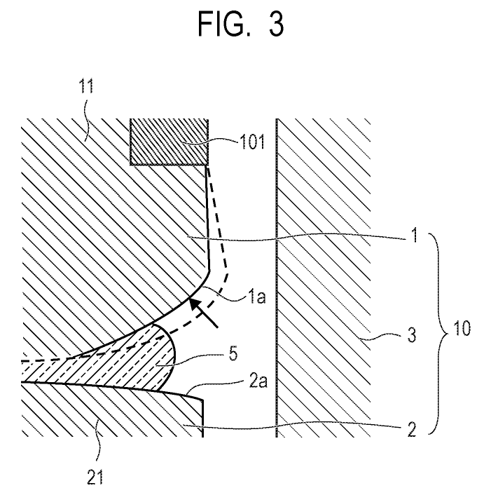

In the demolding step, the controller 20 unloads the press load applied to the upper die member 1 by controlling the operation of the drive system 12. When the press load is unloaded, as illustrated in FIG. 3, the deformation of the outer peripheral portion of the upper die member 1 returns to the original state, and the radius of curvature of the molding surface 1a of the upper die member 1 also returns to the radius of curvature of the unloaded state. The optical element 5 adhering to the molding surface 1a with a large radius of curvature when the press load was loaded is pulled upward on the side of the upper die member 1 as the radius of curvature of the molding surface 1a changes due to the unloading of the press load. As a result, a force is generated at the interface between the molding surface 1a and the optical element 5 to peel off the molding surface 1a and the optical element 5 to make the demolding generated between the molding surface 1a and the optical element 5. Note that it is preferable that the controller 20 performs the demolding step in a state where the optical element 5 is cooled to a temperature lower than the glass transition point of the material to be molded 4 from the viewpoint of curing the molded optical element 5 to a state suitable for demolding.

Furthermore, in the demolding step, the controller 20 controls the operation of the drive system 12 to slide the upper die member 1 upward as illustrated in FIG. 1D. Thus, the controller 20 separates the upper die member 1 and the lower die member 2 from each other in the vertical direction to separate the molding surface 1a and the molding surface 2a from each other. In this manner, the controller 20 opens the molding die 10 so that the optical element 5 after molding can be taken out of the molding die 10. Thereafter, the molded optical element 5 is taken out of the molding die 10 by a transport mechanism (not illustrated) or the like.

Thus, the optical element 5 is manufactured by press molding. The manufactured optical element 5 is a lens such as, but not limited to, a glass lens or the like and is used as an optical element in an interchangeable lens, a camera, a camera mounted in a smartphone, a communication apparatus, or the like.

As described above, in the present embodiment, the upper die member 1 is provided with a dissimilar material part 101 having an elastic modulus smaller than that of the main body part 11 in the outer peripheral portion of the main body part 11. This allows the curvature of the molding surface 1a of the upper die member 1 to be changed during the molding step and the demolding step in response to the change in load during the molding in the present embodiment, and thus the optical element 5 can be easily released from the molding die 10.

On the other hand, in the above-described method of releasing the optical element by applying an external force to the optical element described in Japanese Patent Laid-Open No. 2007-191359, when the adhesion between the optical element and the die is strong, stress is concentrated in the place where the optical element and the releasing member come into contact with each other, and the optical element may be damaged or cracked before releasing the optical element from the die. In particular, since the strength of optical elements having small diameters or thin thicknesses are low, the method described in Japanese Patent Laid-Open No. 2007-191359 tends to cause cracking due to concentration of stress in the optical elements having small diameters or thin thicknesses.

Furthermore, in the method described in Japanese Patent Laid-Open No. H05-147955 for deforming the thin elastic portion of the outer peripheral portion of the die to release the die, a pressurizing member that deforms the elastic portion is required, and a drive system that drives the pressurizing member must be provided separately in the apparatus. Therefore, in the method described in Japanese Patent Laid-Open No. H05-147955, the molding apparatus may become complicated, and the cost of the optical element may be increased.

As described above, according to the present embodiment, the curvature of the molding surface 1a is changed due to a change in the load to release the optical element 5 from the molding die 10. Therefore, according to the present embodiment, the release between the molding die 10 and the optical element 5 can be easily realized without causing scratches or cracks even if the optical element 5 has a small diameter or a thin thickness with low strength.

Note that, in order to simplify the explanation, the case where the dissimilar material part 101 is provided only in the upper die member 1 has been described above, but it is not limited thereto. Similarly, the dissimilar material part 101 having an elastic modulus smaller than that of the main body part 21 may be provided only in the lower die member 2. In this case, the same effect can be obtained. Furthermore, the upper die member 1 may be provided with the dissimilar material part 101 and the lower die member 2 may be provided with the dissimilar material part 101 having an elastic modulus smaller than that of the main body part 21. In this case also, the optical element 5 can be easily released from the molding die 10.

In addition, although the upper die member 1 is moved upward and downward as described above, the material to be molded 4 can also be molded by moving the lower die member 2 in the same manner. Specifically, the controller 20 may control the drive system 12 to slide the lower die member 2 upward toward the upper die member 1 whose position is fixed, or slide the upper die member 1 downward and slide the lower die member 2 upward to press the material to be molded 4.

Furthermore, the upper die member 1 and the lower die member 2 are arranged so that the molding surfaces 1a and 2a face each other in the vertical direction, and are driven by the drive system 12 so as to approach or separate each other in the vertical direction, but they are not limited thereto. The upper die member 1 and the lower die member 2 may be arranged so that the molding surfaces 1a and 2a are face each other in a direction other than the vertical direction, and may be driven by the drive system 12 so as to approach or separate each other in the direction other than the vertical direction.

Note that in a case where the optical element 5 is molded in the same manner as in the first embodiment by using a molding apparatus, which is different from the first embodiment in that the upper die member 1 is not provided with the dissimilar material part 101, it is difficult to release the optical element 5 from the molding surface 1a of the upper die member 1.

### Second Embodiment

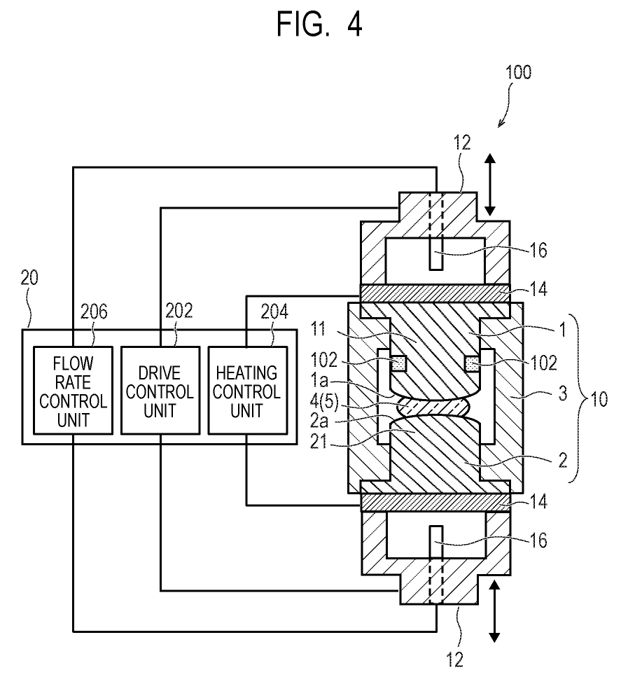

A method for manufacturing an optical element, an apparatus for manufacturing an optical element, and a die according to a second embodiment of the present disclosure will be described with reference to FIG. 4. Note that components similar to those in the first embodiment will be denoted by the same reference numerals and their descriptions will be omitted or simplified.

First, a configuration of an apparatus for manufacturing optical element according to the present embodiment will be described with reference to FIG. 4. FIG. 4 is a schematic diagram illustrating an optical element molding apparatus 100 according to the present embodiment. Note that FIG. 4 illustrates a state of a molding die 10 during a pressing operation.

The molding apparatus 100 according to the present embodiment is an optical element manufacturing apparatus for manufacturing an optical element by press molding, and has the same basic configuration as that of the first embodiment as illustrated in FIG. 4. The present embodiment differs from the first embodiment in that the upper die member 1 has a dissimilar material part 102 instead of the dissimilar material part 101. Note that the other configuration of the molding apparatus 100 according to the present embodiment except for this point is the same as that of the first embodiment.

The dissimilar material part 102 is a material part composed of a material having physical properties different from those of the main body part 11 of the upper die member 1, which is the base material of the die. Specifically, the dissimilar material part 102 is composed of a material having a thermal expansion coefficient greater than that of the main body part 11 which is the base material of the die.

Similar to the dissimilar material part 101 of the first embodiment, the dissimilar material part 102 is provided in the outer peripheral portion of the main body part 11 along the circumferential direction of the side surface of the main body part 11 so as to be positioned outside the cylindrical main body part 11. The dissimilar material part 102 may be continuously or intermittently annularly provided in the outer peripheral portion of the main body part 11 or may be partially provided.

The material of the main body part 11, the material of the main body part 21, and the material of the dissimilar material part 102 are all, for example, cemented carbide. The thermal expansion coefficient of the main body part 11 is, for example, 5.0×10⁻⁶/°C, and the thermal expansion coefficient of the dissimilar material part 102 is, for example, 6.5×10⁻⁶/°C. Note that it is preferable that the dissimilar material part 102 is provided at a position sufficiently distant from the molding surface 1a.

Next, a method for manufacturing an optical element using the molding apparatus 100 according to the present embodiment will be described. The method for manufacturing the optical element according to the present embodiment also includes a heating step, a molding step, a cooling step and a demolding step similar to those of the first embodiment.

In the heating step, as in the first embodiment, the controller 20 controls the output of the heater 14 to heat the entire molding die 10 by the heater 14 and heat the material to be molded 4 arranged in the molding die 10 to make the material to be molded 4 softened. As the material to be molded 4, for example, an optical glass for glass mold having a glass transition point of 510°C may be used. The shape of an optical element to be molded may be a biconcave lens.

Specifically, in the heating step, the controller 20 heats the upper die member 1, the lower die member 2 and the body die 3 to a first temperature (for example, 460°C). When these are heated to the first temperature, the material to be molded 4 is arranged at the center of the lower die member 2. Thereafter, the controller 20 heats the molding die 10 to a second temperature (for example, 570°C), which is higher than the first temperature, and softens the material to be molded 4 until the viscosity of the material to be molded 4 is lowered to a state suitable for molding.

Next, the controller 20 moves to the molding step as in the first embodiment, controls the operation of the drive system 12 to slide the upper die member 1 downward toward the lower die member 2 whose position is fixed, and presses the heated softened material to be molded 4 with a press load. The press load may be set to, for example, 4000 N. Thus, the controller 20 transfers the shapes of the molding surfaces 1a and 2a of the upper die member 1 and the lower die member 2 to the material to be molded 4 to mold the material to be molded 4 to a desired center thickness. Note that it is preferable that the controller 20 performs the molding step in a state in which the material to be molded 4 is heated to a temperature higher than the glass transition point of the material to be molded 4 by the heater 14 as in the first embodiment. Thus, the controller 20 molds the material to be molded 4 into an optical element 5 by pressing the material to be molded 4 between the molding surface 1a and the molding surface 2a while heating the material to be molded 4 by bringing the upper die member 1 and the lower die member 2 close to each other in the vertical direction and thus bringing the molding surface 1a and the molding surface 2a close to each other.

Here, the thermal expansion coefficient of the dissimilar material part 102 is larger than that of the main body part 11, which is a base material of the upper die member 1. Thus, the thermal expansion of the outer peripheral portion of the upper die member 1 provided with the dissimilar material part 102 is larger than that of the central portion of the upper die member 1 due to heat during the heating step and the molding step. As a result, as in the case of the first embodiment illustrated in FIG. 2, the molding surface 1a of the upper die member 1 when heat is applied has a radius of curvature larger than the radius of curvature when heat is not applied. Therefore, the dissimilar material part 102 changes the curvature of the molding surface 1a due to a change in heat. The shape of the molding surface 1a having a larger radius of curvature is transferred to the material to be molded 4. Accordingly, the material to be molded 4 is molded, and an optical element 5 formed of the molded material to be molded 4 is obtained.

After the molding of the material to be molded 4 is completed, the controller 20 moves to the cooling step in the same manner as in the first embodiment, and cools the molding die 10 and the optical element 5 until the molding die 10 and the optical element 5 serving as a molded product become a desired temperature in the cooling step.

When the molding die 10 is cooled in the cooling step, the outer peripheral portion of the upper die member 1 shrinks and deforms more than the central portion of the upper die member 1 due to the presence of the dissimilar material part 102, which has a larger thermal expansion. Due to this shrinkage, as in the case of the first embodiment illustrated in FIG. 3, the radius of curvature of the molding surface 1a of the upper die member 1 becomes smaller than in the molding step. The optical element 5 adhering to the molding surface 1a in the molding step with a large radius of curvature is pulled upward on the side of the upper die member 1 as the curvature of the molding surface 1a changes due to the shrinkage of the thermal expansion. As a result, a force is generated at the interface between the molding surface 1a and the optical element 5 to peel off the molding surface 1a and the optical element 5 to make the demolding generated between the molding surface 1a and the optical element 5.

When the molding die 10 is cooled to a desired temperature, the controller 20 moves to the demolding step as in the first embodiment, and in the demolding step, the controller 20 slides the upper die member 1 upward to open the molding die 10. Note that it is preferable that the controller 20 performs the demolding step in a state where the optical element 5 is cooled to a temperature lower than the glass transition point of the material to be molded 4 as in the first embodiment. Thereafter, the molded optical element 5 is taken out of the molding die 10 by a transport mechanism (not illustrated) or the like.

As described above, in the present embodiment, the upper die member 1 is provided with the dissimilar material part 102 having a thermal expansion coefficient greater than that of the main body part 11 in the outer peripheral portion of the main body part 11. This allows the curvature of the molding surface 1a of the upper die member 1 to be changed during the molding step and the cooling step in response to the change in heat during the molding in the present embodiment, and thus the optical element 5 can be easily released from the molding die 10.

Accordingly, in the present embodiment, the curvature of the molding surface 1a is changed by the change in the heat to release the optical element 5 from the molding die 10. Therefore, according to the present embodiment, the release between the molding die 10 and the optical element 5 can be easily realized without causing scratches or cracks even if the optical element 5 has a small diameter or thin thickness with low strength.

Note that, in order to simplify the explanation, the case where the dissimilar material part 102 is provided only in the upper die member 1 has been described above, but it is not limited thereto. Similarly, the dissimilar material part 102 having a thermal expansion coefficient greater than that of the main body part 21 may be provided only in the lower die member 2. In this case, the same effect can be obtained. Furthermore, the upper die member 1 may be provided with the dissimilar material part 102 and the lower die member 2 may be provided with the dissimilar material part 102 having a thermal expansion coefficient greater than that of the main body part 21. In this case also, the optical element 5 can be easily released from the molding die 10.

The dissimilar material part 102 of the present embodiment may also be used in combination with the dissimilar material part 101 of the first embodiment. That is, one of the dissimilar material parts 101 and 102 may be provided in the upper die member 1, and the other of the dissimilar material parts 101 and 102 may be provided in the lower die member 2. In addition, both of the dissimilar material parts 101 and 102 may be provided in one or both of the upper die member 1 and the lower die member 2.

In the present embodiment also, the controller 20 may press the material to be molded 4 by sliding the lower die member 2 upward toward the upper die member 1 whose position is fixed or by sliding the upper die member 1 downward and sliding the lower die member 2 upward by the drive system 12.

In the present embodiment also, the upper die member 1 and the lower die member 2 may be arranged so that the molding surfaces 1a and 2a face each other in a direction other than the vertical direction, and may be driven so as to approach or separate each other in the direction other than the vertical direction by the drive system 12.

Note that in a case where the optical element 5 is molded in the same manner as in the second embodiment by using a molding apparatus, which is different from the second embodiment in that the upper die member 1 is not provided with the dissimilar material part 102, it is difficult to release the optical element 5 from the molding surface 1a of the upper die member 1.

### Third Embodiment

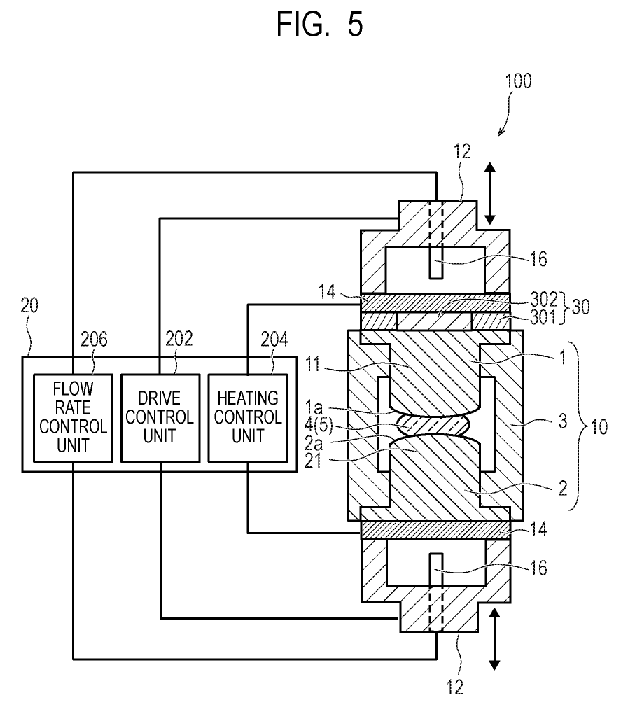

A method for manufacturing an optical element, an apparatus for manufacturing an optical element, and a die according to a third embodiment of the present disclosure will be described with reference to FIG. 5. Note that components similar to those in the first and second embodiments will be denoted by the same reference numerals and their descriptions will be omitted or simplified.

First, the configuration of an apparatus for manufacturing an optical element according to the present embodiment will be described with reference to FIG. 5. FIG. 5 is a schematic diagram illustrating an optical element molding apparatus 100 according to the present embodiment. Note that FIG. 5 illustrates a state of a molding die 10 during a pressing operation.

The molding apparatus 100 according to the present embodiment is an optical element manufacturing apparatus for manufacturing an optical element by press molding, and has the same basic configuration as that of the first embodiment, as illustrated in FIG. 5. The present embodiment differs from the first embodiment in that the upper die member 1 includes a composite member 30 instead of the dissimilar material part 101. Note that the other configuration of the molding apparatus 100 according to the present embodiment except for this point is the same as that of the first embodiment.

The composite member 30 is provided on the bottom surface opposite to the molding surface 1a of the main body part 11 in the upper die member 1. The composite member 30 is arranged, for example, between the bottom surface of the main body part 11 of the upper die member 1 and the heater 14 that heats the main body part 11. That is, the upper die member 1 is provided with the heater 14 via the composite member 30.

The composite member 30 is a material part that includes a first member 301 which is a portion having a small thermal conductivity and a second member 302 which is a portion having a thermal conductivity larger than that of the first member 301. The first member 301 is provided at the central portion of the composite member 30. The second member 302 is provided at the outer peripheral portion of the composite member 30 and is positioned outside the first member 301.

The material of the main body part 11 and the material of the main body part 21 are cemented carbide, for example, and the material of the composite member 30 is ceramic, for example. In the composite member 30, the thermal conductivity of the first member 301 having a small thermal conductivity at the central portion is, for example, 20 W/(m·K), and the thermal conductivity of the second member 302 having a large thermal conductivity at the outer peripheral portion is, for example, 170 W/(m·K).

Next, a method for manufacturing an optical element using the molding apparatus 100 according to the present embodiment will be described. The method for manufacturing the optical element according to the present embodiment also includes a heating step, a molding step, a cooling step and a demolding step similar to those of the first embodiment.

In the heating step, the controller 20 controls the output of the heater 14 to heat the entire molding die 10 by the heater 14 and heat the material to be molded 4 arranged in the molding die 10 to make the material to be molded 4 softened. As the material to be molded 4, for example, an optical glass for glass mold having a glass transition point of 510°C may be used. The shape of the optical element to be molded may be a biconcave lens.

Specifically, in the heating step, the controller 20 heats the upper die member 1 including the composite member 30, the lower die member 2 and the body die 3 to a first temperature (for example, 460°C). When these are heated to the first temperature, the material to be molded 4 is arranged at the center of the lower die member 2. Thereafter, the controller 20 heats the molding die 10 to a second temperature (for example, 570°C), which is higher than the first temperature, and softens the material to be molded 4 until the viscosity of the material to be molded 4 is lowered to a state suitable for molding.

Next, the controller 20 moves to the molding step as in the first embodiment, controls the operation of the drive system 12 to slide the upper die member 1 downward toward the lower die member 2 whose position is fixed, and presses the heated softened material to be molded 4 with a press load. The press load may be set to, for example, 4000 N. Thus, the controller 20 transfers the shapes of the molding surfaces 1a and 2a of the upper die member 1 and the lower die member 2 to the material to be molded 4 to mold the material to be molded 4 to a desired center thickness. Note that it is preferable that the controller 20 performs the molding step in a state in which the material to be molded 4 is heated to a temperature higher than the glass transition point of the material to be molded 4 by the heater 14 as in the first embodiment. Thus, the controller 20 molds the material to be molded 4 into an optical element 5 by pressing the material to be molded 4 between the molding surface 1a and the molding surface 2a while heating the material to be molded 4 by bringing the upper die member 1 and the lower die member 2 close to each other in the vertical direction and thus bringing the molding surface 1a and the molding surface 2a close to each other.

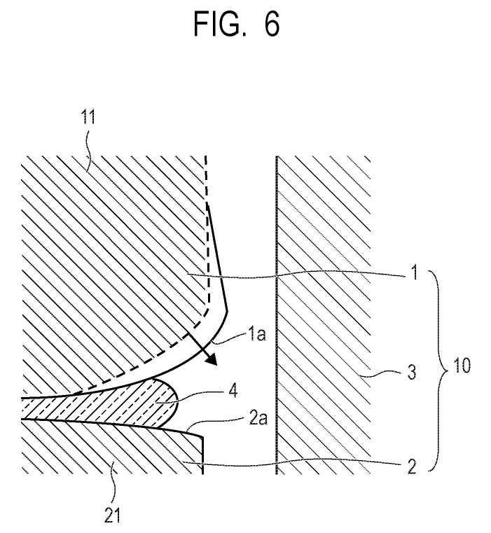

Here, in the composite member 30, the thermal conductivity of the second member 302 at the outer peripheral portion is larger than that of the first member 301 at the central portion. Therefore, the amount of heat flowing into the upper die member 1 from the heater 14 provided in the upper die member 1 via the composite member 30 is larger at the outer peripheral portion than that at the central portion of the upper die member 1. Therefore, in the upper die member 1, a temperature distribution occurs where the central portion is at a lower temperature and the outer peripheral portion is at higher temperature than the central portion, and the thermal expansion of the outer peripheral portion of the upper die member 1 is larger than that of the central portion of the upper die member 1 due to the temperature distribution. As a result, as illustrated in FIG. 6, the molding surface 1a of the upper die member 1 when heat is applied has a radius of curvature larger than the curvature when heat is not applied. Thus, the composite member 30 changes the curvature of the molding surface 1a due to a change in heat. The shape of the molding surface 1a having a larger curvature radius is transferred to the material to be molded 4. Accordingly, the material to be molded 4 is molded, and an optical element 5 formed of the molded material to be molded 4 is obtained.

After the molding of the material to be molded 4 is completed, the controller 20 moves to the cooling step in the same manner as in the first embodiment, and cools the molding die 10 and the optical element 5 until the molding die 10 and the optical element 5 serving as a molded product become a desired temperature in the cooling step.

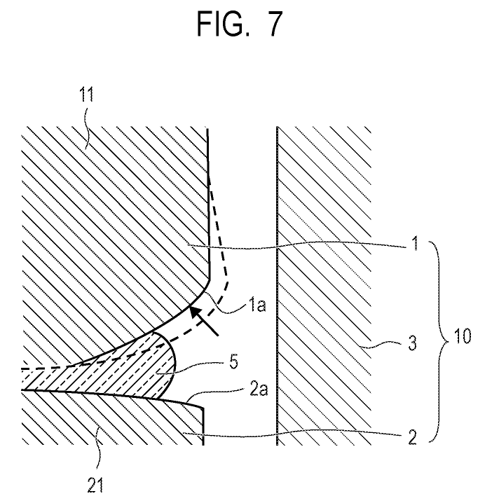

When the molding die 10 is cooled in the cooling step, the upper die member 1 is more likely to be cooled at the outer peripheral portion than the central portion due to the difference in thermal conductivity between the first member 301 and the second member 302 in the composite member 30. As a result, the temperature distribution occurs where the central portion is at a high temperature and the outer peripheral portion is at a lower temperature than the central portion, which is opposite of that during the molding step, by the progress of the cooling step. Due to this temperature distribution, the outer peripheral portion of the upper die member 1 largely shrinks and deforms compared with the central portion of the upper die member 1. Due to this shrinkage, as illustrated in FIG. 7, the radius of curvature of the molding surface 1a of the upper die member 1 is smaller compared with that in the molding step. The optical element 5 adhering to the molding surface 1a in the molding step having the large radius of curvature is pulled upward on the side of the upper die member 1 with a change in the curvature of the molding surface 1a due to the shrinkage of the thermal expansion. As a result, a force is generated at the interface between the molding surface 1a and the optical element 5 to peel off the molding surface 1a and the optical element 5 to make the demolding generated between the molding surface 1a and the optical element 5.

When the molding die 10 is cooled to a desired temperature, the controller 20 moves to the demolding step as in the first embodiment, and in the demolding step, the controller 20 slides the upper die member 1 upward to open the molding die 10. Note that it is preferable that the controller 20 performs the demolding step in a state where the optical element 5 is cooled to a temperature lower than the glass transition point of the material to be molded 4 as in the first embodiment. Thereafter, the molded optical element 5 is taken out of the molding die 10 by a transport mechanism (not illustrated) or the like.

As described above, in the present embodiment, the composite member 30 having different thermal conductivity between the central portion and the outer peripheral portion is provided at the bottom of the upper die member 1. This allows the curvature of the molding surface 1a of the upper die member 1 to be changed during the molding step and the demolding step in response to the change in the heat during the molding in the present embodiment, and thus the optical element 5 can be easily released from the molding die 10.

Accordingly, in the present embodiment, the curvature of the molding surface 1a is changed by the change in the heat to release the optical element 5 from the molding die 10. Therefore, according to the present embodiment, the release between the molding die 10 and the optical element 5 can be easily realized without causing scratches or cracks even if the optical element 5 has a small diameter or thin thickness with low strength.

Note that, in order to simplify the explanation, the case where the composite member 30 is provided only on the upper die member 1 has been described above, but it is not limited to thereto. Similarly, the composite member 30 may be provided only on the lower die member 2. In this case, the same effect can be obtained. Furthermore, the upper die member 1 may be provided with the composite member 30 and the lower die member 2 may be provided with the composite member 30. In this case also, the optical element 5 can be easily released from the molding die 10.

Furthermore, in the molding die 10 having one or both of the dissimilar material parts 101 and 102 as in the first or second embodiment or a combination thereof, the composite member 30 may be provided on one or both of the upper die member 1 and the lower die member 2.

In the present embodiment also, the controller 20 may press the material to be molded 4 by sliding the lower die member 2 upward toward the upper die member 1 whose position is fixed or by sliding the upper die member 1 downward and sliding the lower die member 2 upward by the drive system 12.

In the present embodiment also, the upper die member 1 and the lower die member 2 may be arranged so that the molding surfaces 1a and 2a face each other in a direction other than the vertical direction, and may be driven so as to approach or separate each other in the direction other than the vertical direction by the drive system 12.

Note that in a case where the optical element 5 is molded in the same manner as in the third embodiment by using a molding apparatus, which is different from the third embodiment in that the upper die member 1 is not provided with the composite member 30, it is difficult to release the optical element 5 from the molding surface 1a of the upper die member 1.

### Fourth Embodiment

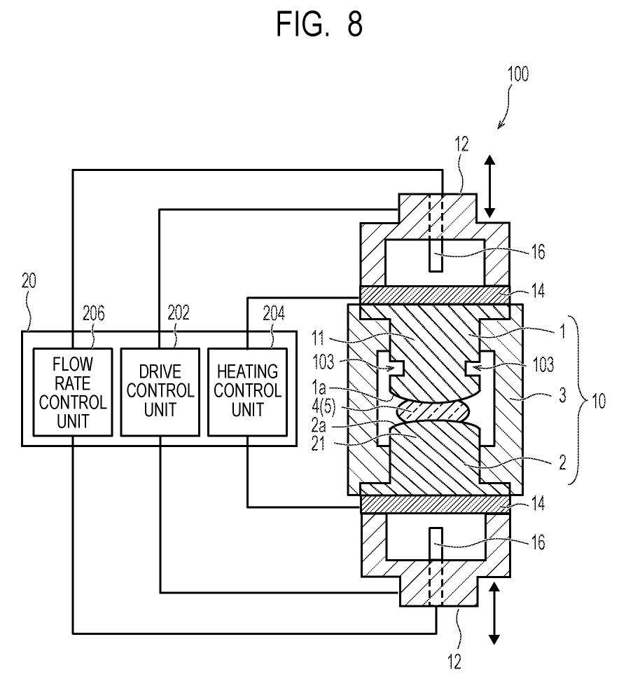

A method for manufacturing an optical element, an apparatus for manufacturing an optical element, and a die according to a fourth embodiment of the present disclosure will be described with reference to FIG. 8. Note that components similar to those in the first to third embodiments will be denoted by the same reference numerals and their descriptions will be omitted or simplified.

The molding apparatus 100 according to the present embodiment is an optical element manufacturing apparatus for manufacturing an optical element by press molding, and has the same basic configuration as that of the first embodiment, as illustrated in FIG. 8. The present embodiment differs from the first embodiment in that the upper die member 1 has a slit 103 instead of the dissimilar material part 101. Note that the other configuration of the molding apparatus 100 according to the present embodiment except for this point is the same as that of the first embodiment.

The slit 103 is a groove-like space provided on the side surface of the main body part 11 along the circumferential direction of the side surface of the cylindrical main body part 11. The slit 103 may be formed in an annular shape continuously or intermittently on the side surface of the upper die member 1 or may be partially formed.

The material of the main body part 11 and the material of the main body part 21 are, for example, stainless steel. The elastic modulus of the main body part 11 is, for example, 200 GPa. Note that it is preferable that the slit 103 is formed at a position sufficiently distant from the molding surface 1a.

The outer peripheral portion of the upper die member 1 provided with the slit 103 has a lower elastic modulus than the central portion. Therefore, as in the case where the dissimilar material part 101 having a low elastic modulus of the first embodiment are provided, the outer peripheral portion deforms when a press load is applied in the molding step, and the molding surface 1a molds the material to be molded 4 with a shape having a radius of curvature larger than the radius of curvature when no load is applied.

Furthermore, when the press load is unloaded in the demolding step, the outer peripheral portion of the upper die member 1 provided with the slit 103 is deformed in the same manner as in the case where the dissimilar material part 101 having a low elastic modulus of the first embodiment are provided. Thus, the deformation of the outer peripheral portion of the upper die member 1 returns to the original state, and the curvature of the molding surface 1a also returns to the shape at the time of no load. The optical element 5 adhering to the molding surface 1a at the time of the load with the large radius of curvature is pulled upward on the side of the upper die member 1 in accordance with a change in the radius of curvature of the molding surface 1a due to the unloading of the press load. As a result, a force is generated at the interface between the molding surface 1a and the optical element 5 to peel off the molding surface 1a and the optical element 5 to make the demolding generated between the molding surface 1a and the optical element 5.

Not only providing the dissimilar material parts 101 and 102 as in the first and second embodiments, but as in the present embodiment, the molding surface 1a can be deformed by reducing the apparent elastic modulus by providing the slit 103 which is a space portion. In this case also, the optical element 5 can be easily released from the molding die 10.

Note that, in order to simplify the explanation, the case where the slit 103 is provided only in the upper die member 1 has been described above, but it is not limited thereto. Similarly, the slit 103 may be provided only in the lower die member 2. In this case, the same effect can be obtained. Furthermore, the slit 103 may be provided in the upper die member 1 and a slit 103 may be provided in the lower die member 2. In this case also, the optical element 5 can be easily released from the molding die 10.

In the first, second or third embodiments or a combination thereof, the slits 103 may be provided in either or both of the upper die member 1 and the lower die member 2 in the molding die 10 in which some or all of the dissimilar material parts 101 and 102 and the composite member 30 are provided.

### Fifth Embodiment

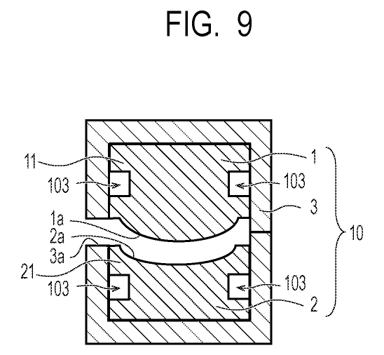

A method for manufacturing an optical element, an apparatus for manufacturing an optical element, and a die according to a fifth embodiment of the present disclosure will be described with reference to FIG. 9. Note that components similar to those in the first to fourth embodiments will be denoted by the same reference numerals and their descriptions will be omitted or simplified.

In the first to fourth embodiments, the cases of molding the optical elements by press molding has been described, but the optical element can also be molded by injection molding of a thermoplastic resin or the like. In the present embodiment, a case of molding an optical element by injection molding will be described.

FIG. 9 is a cross-sectional view illustrating a molding die 10 used in molding an optical element by injection molding in the present embodiment. As illustrated in the drawing, the molding die 10 includes an upper die member 1, a lower die member 2, and a body die 3. The upper die member 1 and the lower die member 2 are vertically arranged so that the molding surfaces 1a and 2a of the respective main body parts 11 and 21 face each other in the vertical direction, and are held by the body die 3. The upper die member 1 and the lower die member 2 are configured so that a press load can be applied between the molding surfaces 1a and 2a in a molding step by injection molding.

For example, stainless steel may be used as the material of the main body part 11 and the material of the main body part 21. Furthermore, as in the fourth embodiment, slits 103 are formed on the side surface of the cylindrical main body part 11 and the side surface of the cylindrical main body part 21.

A material to be molded can be introduced between the molding surfaces 1a and 2a of the molding die 10 by pouring the material to be molded from an opening 3a formed in the body die 3. As the material to be molded, a thermoplastic resin such as a cycloolefin resin may be used. For example, the molding surface 1a of the upper die member 1 may be convex and the molding surface 2a of the lower die member 2 may be concave so that the shape of the optical element to be molded is a concave meniscus lens.

Also in injection molding, since the slit 103 is provided in the molding die 10, the elastic modulus of the outer peripheral portions of the upper die member 1 and the lower die member 2 becomes smaller than those of the central portions. Thus, in the molding step by injection molding, the material to be molded is molded in a state where the radii of curvature of the molding surfaces 1a and 2a are larger by the press load during injection molding. In addition, the unloading of the press load during the demolding step causes the radii of curvature of the deformed molding surfaces 1a and 2a to return to the original states, so that the demolding occurs at the interface between the molding surfaces 1a and 2a and the optical element. Note that, in the molding step, the thermoplastic resin may be injected between the molding surfaces 1a and 2a with the temperature of the thermoplastic resin being, for example, 250°C and the temperature of the molding die 10 being, for example, 135°C to perform injection molding.

In the injection molding of the thermoplastic resin as in the present embodiment, the curvatures of the molding surfaces 1a and 2a can be changed by changing the load during the molding by forming regions each having a smaller elastic modulus at the outer peripheral portions of the upper die member 1 and the lower die member 2 by the slits 103. Thus, the optical element can be easily released from the molding die 10.

Note that, although the case where the slits 103 are formed in both the upper die member 1 and the lower die member 2 has been described above, the slit 103 may be provided in one of the upper die member 1 and the lower die member 2. In addition, one or both of the dissimilar material part 101 of the first embodiment and the dissimilar material part 102 of the second embodiment may be provided instead of the slit 103 or together with the slit 103.

Note that, although the embodiments of the present disclosure have been described with examples of molding optical elements, the molding die and the manufacturing apparatus of the present disclosure may be applied to a member other than the optical element. Although the embodiments have been described with examples in which the curvature of the molding surface changes with changes in the heat or the load in both the cooling step and the demolding step, the curvature of the molding surface may be deformed in either of the cooling step or the demolding step depending on the temperature range used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-202515, filed November 20, 2024, which is hereby incorporated by reference herein in its entirety.

What is claimed is:

1. A method for manufacturing a member, the method comprising:
a molding step of molding, by using a die having a first die member with a first molding surface and a second die member with a second molding surface and causing the first molding surface and the second molding surface to approach each other, a material to be molded into a member by heating and pressing the material to be molded between the first molding surface and the second molding surface;
a cooling step of cooling the die after the molding step; and
a demolding step of demolding the member from the die after the molding step,
wherein at least one die member of the first die member and the second die member has a material part or a space part that changes a curvature of the first molding surface or the second molding surface, which is a molding surface, due to a change in heat or load in the cooling step or the demolding step.

2. The method for manufacturing a member according to claim 1,
wherein the at least one die member has a main body part having the molding surface, and
wherein physical properties of the material part are different from physical properties of the main body part.

3. The method for manufacturing a member according to claim 2,
wherein an elastic modulus of the material part is smaller than an elastic modulus of the main body part, and
wherein a coefficient of thermal expansion of the material part is larger than a coefficient of thermal expansion of the main body part.

4. The method for manufacturing a member according to claim 2, wherein the material part is provided outside the main body part.

5. The method for manufacturing a member according to claim 1,
wherein the at least one die member has a main body part having the molding surface, and
wherein the space part is provided outside the main body part.

6. The method for manufacturing a member according to claim 1,
wherein the at least one die member has a main body part having the molding surface,
wherein the material part is arranged between a heating unit that heats the main body part and the main body part, and
wherein the material part has a first portion and a second portion having a heat conductivity greater than that of the first portion.

7. The method for manufacturing a member according to claim 6, wherein the second portion is provided outside the first portion.

8. The method for manufacturing a member according to claim 1, wherein the demolding step is started after starting the cooling step.

9. The method for manufacturing a member according to claim 1, wherein the material to be molded is glass.

10. The method for manufacturing a member according to claim 1,
wherein the molding step is performed in a state where the material to be molded is heated to a temperature higher than a glass transition temperature of the material to be molded, and
wherein the demolding step is performed in a state where the member is cooled to a temperature lower than the glass transition temperature.

11. The method for manufacturing a member according to claim 1, wherein the member is a glass lens.

12. An apparatus for manufacturing a member, the apparatus comprising:
a die having a first die member with a first molding surface and a second die member with a second molding surface;
a drive system that causes the first molding surface and the second molding surface to approach each other or to separate from each other; and
a temperature control unit that controls a temperature of the die,
wherein at least one die member of the first die member and the second die member has a material part or a space part that changes a curvature of the first molding surface or the second molding surface, which is a molding surface, due to a change in heat or load.

13. The apparatus for manufacturing a member according to claim 12,
wherein the at least one die member has a main body part having the molding surface, and
wherein physical properties of the material part are different from physical properties of the main body part.

14. The apparatus for manufacturing a member according to claim 13,
wherein an elastic modulus of the material part is smaller than an elastic modulus of the main body part, and
wherein a coefficient of thermal expansion of the material part is larger than a coefficient of thermal expansion of the main body part.

15. The apparatus for manufacturing a member according to claim 13, wherein the material part is provided outside the main body part.

16. The apparatus for manufacturing a member according to claim 12,
wherein the at least one die member has a main body part having the molding surface, and
wherein the space part is provided outside the main body part.

17. The apparatus for manufacturing a member according to claim 12,
wherein the at least one die member has a main body part having the molding surface,
wherein the material part is arranged between a heating unit that heats the main body part and the main body part, and
wherein the material part has a first portion and a second portion having a heat conductivity greater than that of the first portion.

18. The apparatus for manufacturing a member according to claim 17, wherein the second portion is provided outside the first portion.

19. A die comprising:
a first die member having a first molding surface; and
a second die member having a second molding surface,
wherein at least one die member of the first die member and the second die member has a material part or a space part that changes a curvature of the first molding surface or the second molding surface, which is a molding surface, due to a change in heat or load.

20. A non-transitory computer-readable recording medium storing a program executable to perform the method according to claim 1.
